(19) United States
(12) Patent Application Publication
(10) Pub. No.: US 2007/0092115 A1
(43) Pub. Date: Apr. 26, 2007

(54) Method and system for detecting biometric liveness

(76) Inventors: David B. Usher, Waltham, MA (US); John Marshall, Farnborough (GB); David F. Muller, Boston, MA (US); Gregory L. Heacock, Auburn, WA (US)

Correspondence Address: MCANDREWS HELD & MALLOY, LTD, 500 WEST MADISON STREET, SUITE 3400, CHICAGO, IL, 60661, US

(21) Appl. No.: 11/258,749

(22) Filed: Oct. 26, 2005

(51) Int. Cl. G06K 9/00

(52) U.S. Cl. 382/117

(57) ABSTRACT

A method and system captures a sequence of images of a biometric wherein the images include a common reference. The system aligns the images represented by the image data with respect to the common reference. Thereafter, the system analyzes an attribute of the biometric represented in the sequence of images to determine whether the attribute changes in the sequence of images in accordance with a living source.

### CROSS-REFERENCE TO RELATED APPLICATIONS

This application is related to U.S. patent application Ser. No. 11/028,726, entitled “Method and System for Automatically Capturing an Image of a Retina” and filed Jan. 3, 2005; Ser. No. 10/038,168, entitled “System For Capturing An Image Of The Retina For Identification” and filed Oct. 23, 2001; and Ser. No. 09/705,133, entitled “Method For Generating A Unique And Consistent Signal Pattern For Identification Of An Individual” and filed Nov. 2, 2000.

### STATEMENT REGARDING FEDERALLY SPONSORED RESEARCH OR DEVELOPMENT

### N/A

### TECHNICAL FIELD

The present invention is directed to a method and system for use in a biometric image capturing system and more particularly to such a method and system that detects whether the biometric is from a living source.

### BACKGROUND OF THE INVENTION

Various devices are known that use a biometric to record an attribute of an individual, such as an image of a face, fingerprint, eye, etc. to identify an individual. With respect to eye biometrics, devices are known that detect a vascular pattern in a portion of an individual's retina to identify the individual. Examples of such devices are disclosed in U.S. Pat. Nos. 4,109,237; 4,393,366; and 4,620,318. In these devices, a collimated beam of light is focused on a small spot of the retina and the beam is scanned in a circular pattern to generate an analog signal representing the vascular structure of the eye intersecting the circular path of the scanned beam. In the U.S. Pat. No. 4,393,366, the circular pattern is outside of the optic disk or optic nerve and in the U.S. Pat. No. 4,620,318, the light is scanned in a circle centered on the fovea. These systems use the vascular structure outside of the optic disk because it was thought that only this area of the retina contained sufficient information to distinguish one individual from another. However, these systems have problems in consistently generating a consistent signal pattern for the same individual. For example, the tilt of the eye can change the retinal structure “seen” by these systems such that two distinct points on the retina can appear to be superimposed. As such, the signal representing the vascular structure of an individual will vary depending upon the tilt of the eye. This problem is further exacerbated because these systems analyze data representing only that vascular structure which intersects the circular path of scanned light, if the individual's eye is not in exactly the same alignment with the system each time it is used, the scanned light can intersect different vascular structures, resulting in a substantially different signal pattern for the same individual.

Moreover, biometric systems have not been able to accurately detect whether biometric data is artificially created or from a living source. Biometric systems that rely on static biometric data are particularly susceptible to being tricked by artificial or fake biometrics.

### BRIEF SUMMARY OF THE INVENTION

In accordance with the present invention, the disadvantages of prior biometric methods and systems have been overcome. The method and system of the present invention detects whether captured images of a biometric are from a living source. As such, it is extremely difficult to trick the biometric system of the present invention.

More particularly, in accordance with one embodiment of the method and system of the present invention, a sequence of images of a biometric is captured wherein the images include a common reference. The system aligns the images represented by the image data with respect to the common reference. Thereafter, the system analyzes an attribute of the biometric represented in the sequence of images to determine whether the attribute changes in the sequence of images in accordance with a living source.

In one embodiment of the present invention, the attribute that is analyzed is the width of at least one blood vessel. In another embodiment of the present invention the attribute that is analyzed is the intensity of pixels associated with at least one blood vessel. If the biometric is an image of an eye, other attributes that may be analyzed include the absorption or reflectivity of portions of the eye to different wavelengths of light; movement of the eye, e.g. Saccadic movements, or, alternatively controlled movement of the eye, etc.

In accordance with another embodiment of the present invention, the system captures a sequence of images of an eye where the images are represented by image data and the images in the sequence include at least one blood vessel. The system then locates the same blood vessel in each of the images of the sequence from the respective image data. Thereafter, the system determines from the image data associated with the respective images in the sequence whether the located blood vessel is pulsing to detect whether the captured images of the eye are from a living source or not.

These and other advantages and novel features of the present invention, as well as details of an illustrated embodiment thereof, will be more fully understood from the following description and drawings.

### BRIEF DESCRIPTION OF THE SEVERAL VIEWS OF THE DRAWING

FIG. 1 is a side, cross-sectional view of a system for capturing an image of an area of the retina;

FIG. 2 is an illustration of a retinal image and a boundary area of the optic disk identified in accordance with the present invention from the image's pixel data;

FIG. 3 is a flow chart illustrating a method of automatically capturing a retinal image in accordance with the present invention;

FIG. 4 is an illustration of a method for locating the optic disk on the image;

FIG. 5 is a flow chart illustrating an alternative method for locating the optic disk on the image;

FIG. 6 is a flow chart illustrating a method for finding the closest fitting circle to the optic disk;

FIG. 7 is a flow chart illustrating a method for distorting the closest fitting circle into an ellipse that more closely matches the shape of the optic disk on the image;

FIG. 8 is an illustration of an ellipse and the 5 parameters defining the ellipse as well as the boundary or edge area about the periphery of the ellipse used to generate a unique signal pattern in accordance with one method of the invention;

FIG. 9 is a flow chart illustrating one embodiment of the method for generating a signal pattern from the pixel data at a number of positions determined with respect to the boundary area of the optic disk;

FIG. 10 is an illustration of two signal patterns generated for the same individual from two different images of the individual's retina taken several months apart;

FIG. 11 is a signal pattern generated from the retinal image of FIG. 3 for another individual;

FIG. 12 is a flow chart illustrating an active contour method for finding a contour representative of a shape of the optic disk;

FIG. 13 illustrates calculated model and raw data resulting from a first vessel detection step;

FIG. 14 is an enhanced composite image of an optic disk with an ellipse fitted thereto;

FIG. 15 is an illustration of an intensity profile recorded as a function of angle along the circumference of a radius-specific-scan;

FIG. 16 illustrates a reconstructed vessel pattern signal;

FIG. 17 is a flow chart illustrating a vessel detection method;

FIG. 18 is an illustration of an image of a retina with the optic disk bounded by an ellipse E and various detected blood vessels being represented by the radius, R, and θ and wherein the width of the blood vessel along its length varies over time due to the pulsing of the blood through the vessel;

FIG. 19 is a flow chart depicting one embodiment of detecting whether a biometric is from a living source;

FIG. 20 is a flow chart illustrating the details of several blocks of the flow chart of FIG. 19; and

FIG. 21 is another embodiment of a method for detecting whether a biometric is from a living source in accordance with the present invention.

### DETAILED DESCRIPTION OF THE INVENTION

The system 110 of the present invention automatically captures a pixel image or bit mapped image of an area of the retina 119 of an eye 120 and, in particular, an image of the optic disk 10 and surrounding area. It has been found that the optic disk 10 contains the smallest amount of information in the eye to uniquely identify an individual. Because the eye pivots about the optic nerve, an image of the retina centered on the optic disk is the most stable and repeatable image that can be obtained. The system 110 of the present invention further has a minimal number of optical components resulting in an extremely compact device that is sufficiently small so as to be contained in a portable and/or hand held housing 112. This feature allows the system 110 of the present invention to be used with portable communication devices including wireless Internet access devices, PALM computers, laptops, etc. as well as standard, personal computers. The system 110 of the present invention provides the captured image, represented by a single image frame or a sequence of image frames, to such a device for communication of the image via the Internet or other network to a central location for verification and authentication of the individual's identity. The system of the present invention is also suitable for use at fixed locations. The captured image can be analyzed at the same location at which the image is scanned or at a location remote therefrom.

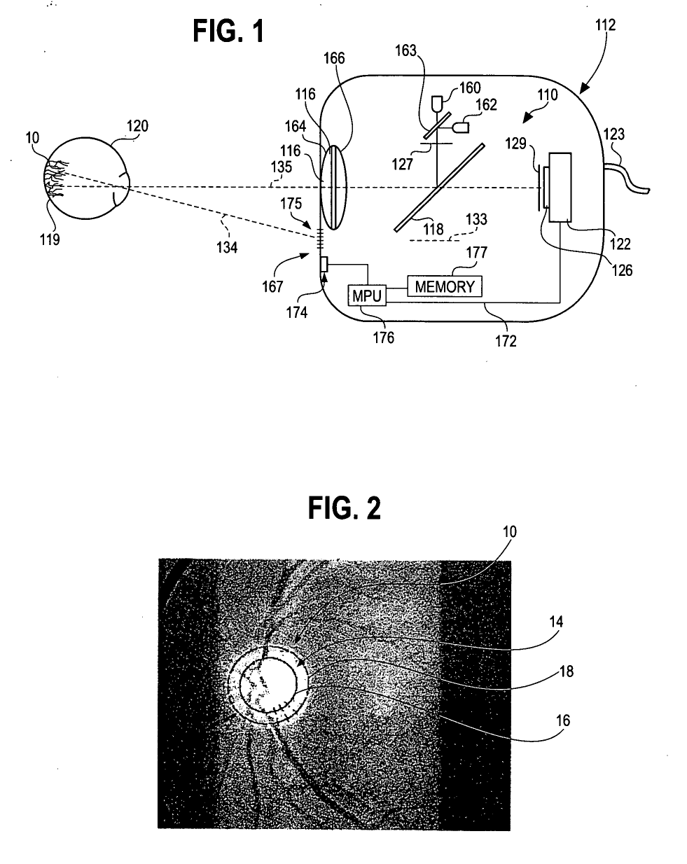

As shown in FIG. 1, the non-scanned light source of the system 110 includes at least one light emitting diode (LED) 160 to provide light for illuminating an area of the retina 119 containing the optic disk 10. The light from the LED 160 is directed to the retina 119 by a partially reflecting mirror 118 and an objective lens 116 which determines the image field angle 117. The lens preferably has an effective focal length between 115 and 130 millimeters. In particular, light from the LED 160 is reflected by the mirror 118 through the objective lens 116 to illuminate an area of the retina about a point intersecting a centerline 135 of the lens 116.

Light reflected from the illuminated area of the retina 119 is picked up by the objective lens 116. The objective lens 116 directs the light reflected from the retina through the partially reflective mirror 118 to a pin hole lens 126 that is positioned in front of and with respect to the image capturing surface of an image sensor such as a CCD camera 122, a CMOS image sensor or other image capturing device. The pin hole lens 126 ensures that the system 110 has a large depth of focus so as to accommodate a wide range of eye optical powers. The CCD camera 122 captures an image of the light reflected from the illuminated area of the retina and generates a signal representing the captured image. In a preferred embodiment, the center of the CCD camera 122 is generally aligned with the centerline of the lens 116 so that the central, i.e. principal image captured is an individual's optic disk. It is noted that in a preferred embodiment of the invention the CCD camera 122 provides digital bit mapped image data representing the captured image.

In a preferred embodiment, a pair of polarizers 127 and 129 that are cross-polarized are inserted into the optical path of the system to eliminate unwanted reflections that can impair the captured image. More particularly, the polarizer 127 is disposed between the light source 160 and the partially reflecting mirror 118 so as to polarize the light from the source 160 in a first direction. The polarizer 129 is such that it will not pass light polarized in the first direction. As such, the polarizer 129 prevents light from the LED 160 from reaching the CCD camera 122. The polarized light from the LED 160 becomes randomized as the light passes through the tissues of the eye to the retina so that the light reflected from the retina to the lens 116 is generally unpolarized and will pass through the polarizer 129 to the CCD camera 122. However, any polarized light from the LED 160 reflecting off of the cornea 131 of the eye will still be polarized in the first direction and will not pass through the polarizer 129 to the CCD camera 122. Thus, the polarizers 127 and 129 prevent unwanted reflections from the light source 160 and cornea 131 from reaching the CCD camera 122 so that the captured image does not contain bright spots representing unwanted reflections. If desired, a third polarizer 133 as shown in FIG. 1 can be positioned generally parallel to the polarizer 127 but on the opposite side of the partially reflective mirror 118 to eliminate unwanted reflections in that area of the housing as well. This third polarizer may or may not be needed depending on the configuration of the system.

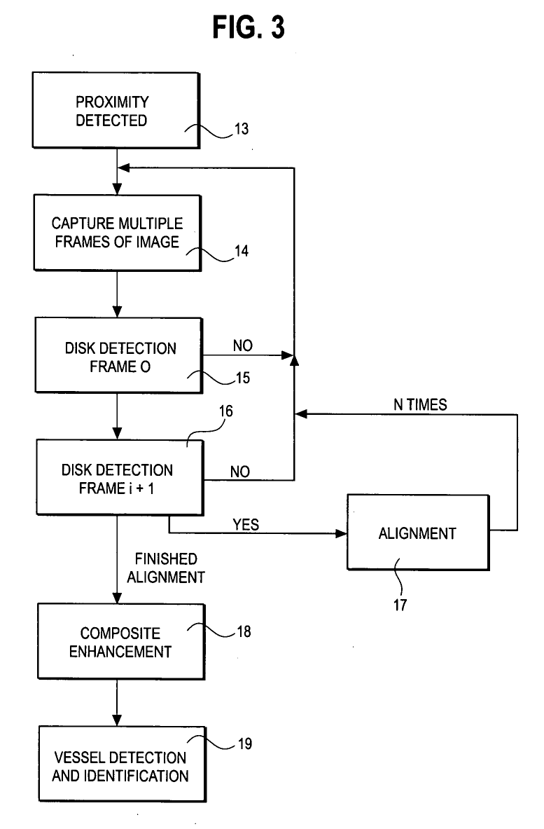

The output of the CCD camera 122 representing the captured image is coupled via a cable 123 to a personal computer, laptop, PALM computer or the like capable of communicating with a remote computer that analyzes the data to identify or authenticate the identity of an individual. Alternatively, the output of the CCD camera is stored or buffered in a memory 177 and transmitted, under the control of a microprocessor 176, directly to the remote computer for analysis. However, before transmitting data representing the captured image, the microprocessor 176 determines whether the captured image is sufficient to provide identification data, i.e. data used to identify an individual or animal as discussed in detail below with reference to FIG. 3. If the captured image is determined to be sufficient, the image is stored for analysis on site or the image is transmitted to a host computer to generate the identification data and to authenticate the identity of the individual or animal. It is noted that besides coupling image data out from the CCD camera 122, the cable 123 also preferably provides power to the system 110. Alternately, a battery 126 can be mounted in the housing 112 to provide power to various components of the system 110. Further, the system 110 can include a wireless communication interface such as an IR or RF interface instead of the cable 123 to communicate the captured image data to another device.

In accordance with a preferred embodiment of the system 110, the LED 160 is a red LED and the light source also includes a green LED 162 that are simultaneously actuated to illuminate the retina. The light from the red LED 160 and the light from the green LED 162 are combined by a combiner 163 or partially reflected mirror coated so as to pass red light from the red LED 160 and to reflect green light from the green LED 162. It has been found that enhanced contrast between the blood vessels of the retina and the background is achieved by illuminating the retina with light having wavelengths in the red spectrum and the green spectrum. However, light from only a red LED may be used to illuminate the retina. Further, wavelengths of light other than red and/or green may be used to illuminate the retina as well.

Further, the objective lens 116 has a first surface 164 and a second surface 166, one or both of which are formed as a rotationally symmetric aspheric surface defined by the following equation.

$$Z = \frac{C {r}^{2}}{1 + \sqrt{1 - ( 1 + k ) {C}^{2} {r}^{2}}} + {A}_{1} {r}^{2} + {A}_{2} {r}^{4} + {A}_{3} {r}^{6} .$$

By forming one or both of the surfaces 164, 166 of the lens 116 as a rotationally symmetric asphere, the quality of the image captured can be substantially increased.

The system 110 further includes a proximity detector in the form of an optical proximity detector or a transducer 174 such as an ultrasound transducer so as to determine when an individual is at a predetermined distance from the system 110. The ultrasound transducer 174 is positioned adjacent the channel 172 and preferably below the channel 172; The transducer 174 is operated in a transmit and a receive mode. In the transmit mode, the ultrasound transducer 174 generates an ultrasound wave that reflects off of an area of the user's face just below the eye 120, such as the user's cheek. The ultrasound wave reflected off of the user's face is picked up by the transducer 174 in a receive mode. From the time at which the wave is sent, the time at which the wave is received, and the speed of the wave through air, the distance between the system 110 and the individual can be determined by a microprocessor 176 or a dedicated integrated circuit (I.C.). The microprocessor 176 or I.C. compares the determined distance between the eye 120 and the system 110 to a predetermined distance value stored in the memory 177, a register or the like, accessible by the microprocessor 176 or I.C. When the microprocessor 176 determines from the output of the ultrasound transducer 174 that the individual is at the predetermined or correct distance, the microprocessor 176 signals the CCD camera 122 to actuate the camera to capture an image of an area of the retina including the optic disk. A system for aligning the eye with the system 110 so that the optic disk is the central image captured is disclosed in U.S. patent application Ser. No. 10/038,168 filed Oct. 23, 2001 and incorporated herein by reference.

In a preferred embodiment, the image captured by the CCD camera 122 is represented by bit mapped digital data provided by the camera 122. The bit mapped image data represents the intensity of pixels forming the captured image. As used herein, bit mapped image data is such that a particular group of data bits corresponds to and represents a pixel at a particular location in the image.

When an image is captured by the camera 122, the microprocessor 176 determines whether the captured image, represented by one or multiple frames of the image, is sufficient for analysis. If a captured image is not sufficient, the microprocessor 176 controls the camera 122 to automatically capture another image. If the microprocessor 176 determines that the capture image is sufficient for analysis, the microprocessor 176 stores the image data, represented by one or multiple frames of the captured image, at least temporarily, before the microprocessor 176 causes the image data to be sent to a host computer to generate the identification data and to authenticate the identity of the individual or animal whose retinal image was captured by the system 110. Alternatively, the microprocessor 176 can generate the identification data as discussed below and then send the identification data to a host computer to perform the authentication process. In a preferred embodiment, whatever data is transmitted from the system 110 is preferably transmitted in encrypted form for security. Moreover, the system's own microprocessor 176 can authenticate the identity of an individual. In such an embodiment, the microprocessor 176 can receive data representing an image of an individual's retina and/or optic disk from a remote location or from an identification card encoded with the data and input to the system 110 for comparison by the microprocessor 176 to the image data captured by the system 110 from the illuminated retina. If the microprocessor 176 determines a match, the identity of the individual is authenticated.

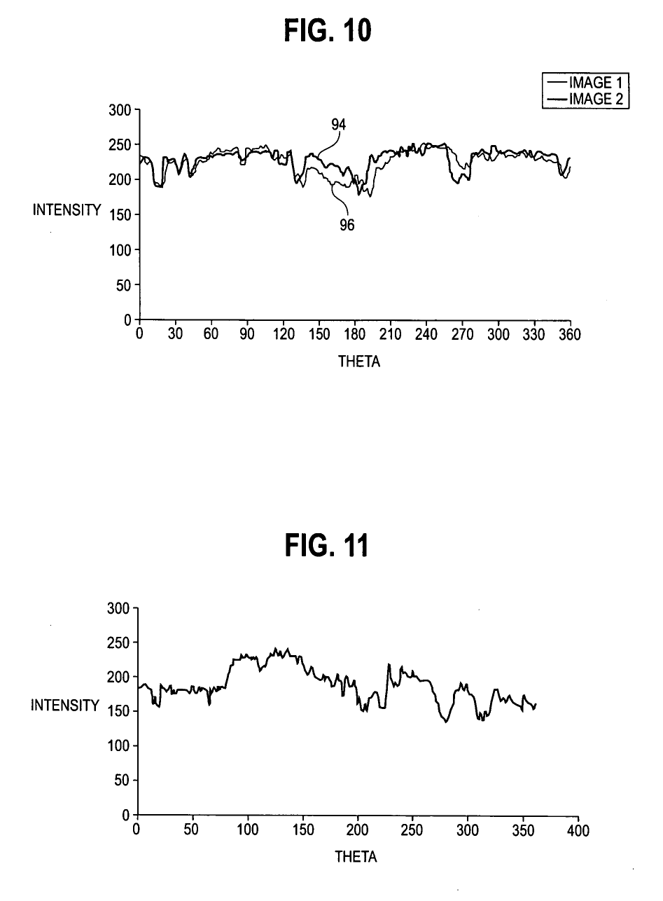

FIG. 2 illustrates a retinal image obtained from the system 110 where the captured image is digitized and analyzed in accordance with the present invention. As can be seen from this image, the optic disk 10 appears on the image as the brightest or highest intensity area. A boundary area 14 of the optic disk 10 found in accordance with the present invention is identified by the area between two concentric ellipses 16 and 18 wherein each ellipse may be a circle. The ellipse 18 is an ellipse that was fit onto the respective optic disk 10 in accordance with the present invention and the ellipse 16 has a predetermined relationship to the ellipse 18 as discussed in detail below. A unique signal pattern is generated for an individual or animal from the average intensity of the pixels within the boundary area 14 at various angular positions along the elliptical path fit onto the image of the optic disk. Examples of signal patterns generated in accordance with the method of this embodiment are depicted in FIGS. 10 and 11 as discussed in detail below. It has been found that the optic disk contains the smallest amount of information in the eye to uniquely identify an individual. Because the eye pivots about the optic nerve, an image of the optic disk is the most stable and repeatable image that can be obtained. As such, the pixel data representing the image of the optic disk is used in accordance with the present invention to generate a unique and consistent signal pattern to identify an individual or animal.

Before generating the unique signal pattern, i.e. the identification data, the system an method of the present invention determines whether a captured image is sufficient to provide the identification data. This feature of the present invention allows an image to be automatically captured and tested for sufficiency. This feature also enables the system to screen out insufficient images at an early point in the analysis to increase the speed and accuracy of the identification system of the present invention.

More particularly, as shown in FIG. 3, the microprocessor 176, at block 13, first determines whether an individual is within close enough proximity of the system 110 so that an image of the individual's retina can be captured as discussed above. When the microprocessor 176 determines that an individual is within the desired proximity of the system 110, the microprocessor, at block 14 controls the camera 122 to capture an image of the eye. Although only one frame of an image need be captured, in a preferred embodiment, the system 110 captures multiple frames of an image of the retina at block 14. Thereafter, the microprocessor analyzes the captured image to find the optic disk. The optic disk represents a marker in the retina that is used as a fixed reference for analyzing the image and generating identification data. Although the optic disk is the preferred marker in accordance with the present invention, other markers may be used as well such as the macula, blood vessel bifurcations, etc. A process for finding a marker such as the optic disk is discussed in detail below.

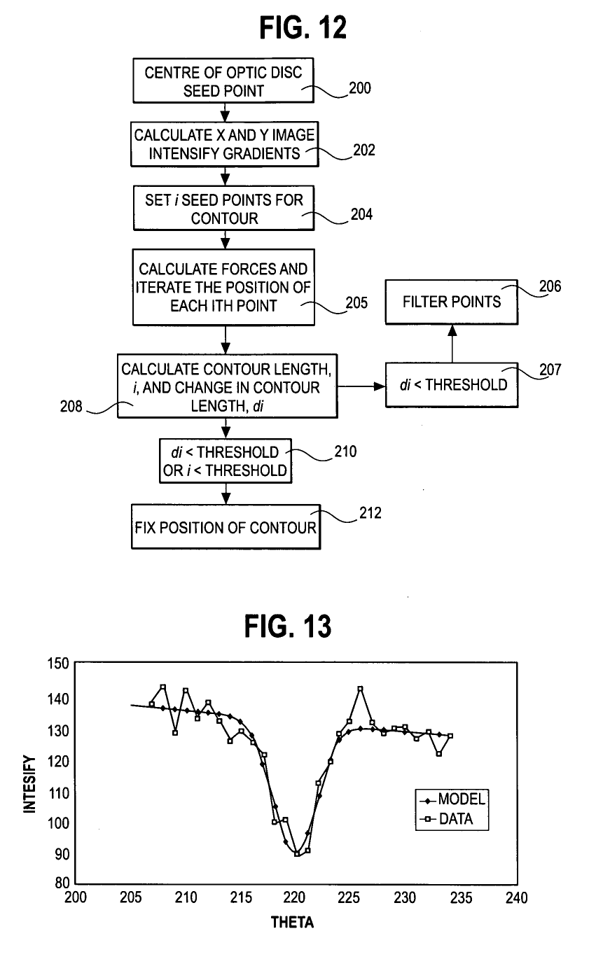

Depending on the speed of the microprocessor 176, a software filter as depicted in FIG. 12 may be implemented at block 14. This filter may not be needed if the disk detection method depicted at block 15 and/or block 16 in FIG. 3 and described in detail with regard to later figures, can be implemented at a speed commensurate with the rate at which image frames are captured. The filter of FIG. 12 uses an active contour method in order to identify a captured image frame of sufficient quality to qualify the image frame as frame 0, i.e. the first frame of a captured image, that is to be further analyzed at block 15.

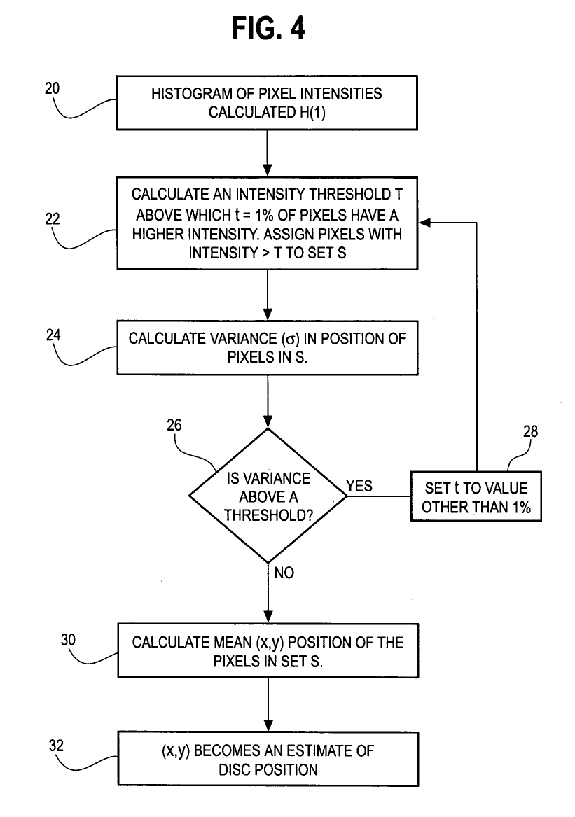

Referring to FIG. 12, the microprocessor 176, at block 200, the microprocessor estimates the location of the center of the optic disk as described below with reference to FIG. 4. The estimated center of the optic disk is a seed point or starting position that the algorithm uses. At block 202 the microprocessor 176 calculates X and Y image intensity gradients, i.e. X and Y directional edge strengths. These edge strengths are associated with pixels that correspond to contour points such that the coordinate of the contour point falls within the bounds of the pixel. Pixel edge strengths are further discussed below with regard to an ellipse fitting method. The only difference is that the filter of FIG. 12 uses X and Y direction edge strengths while the ellipse fitting method uses the modulus of these, i.e. the square root of X*X+Y*Y. At block 204, the starting positions or seed points for the contour of the optic disk are calculated by sampling a continuous circle centered on the estimated seed point center of the optic disk determined at block 200. Typically, the circle is sampled every six degrees creating 60 initial seed points for the contour. It should be apparent that the circle can be sampled at different angles as well. It is further noted, that the radius of the sampled circle is typically set to a value that is two times the expected radius of a typical optic disk. At block 205, the microprocessor 176 calculates an internal force FI and an external force FE for each of the seed points. Specifically, each force has an x and y component. Each of the internal forces FIxi and FIyi, for the ith point is calculated as follows.
FIxi=x(i−1)−2x(i)+x(i+1)
FIyi=y(i−1)−2y(i)+y(i+1)
These equations move the ith point toward the mean position of the ith point's nearest neighbors. Each of the external forces FExi and FEyi for the ith point are calculated as follows.
FExi=abs(E[xi+1][yi])−abs(E[xi−1][yi])
FEyi=abs(E[xi][yi+1])−abs(E[xi][yi−1])
These equations determine the difference between the absolute value of the edge strength of the pixels to the right and left of the ith pixel. The x and y coordinates of the ith contour point, i.e. xi, yi, are then updated using the following equation.
xi=xi+a*FIxi+b*FExi
yi=yi+a*FIyi+b*FEyi
where a and b are constants used to control the absolute strengths of the internal and external forces. At block 208, the microprocessor 176 calculates the contour length, l, and the change in contour lengths, dl. The total perimeter length 1, of the contour is calculated after each iteration along with the difference between this value and the value of l for the previous iteration to provide the change in length, dl. The perimeter length, l is equal to the sum, for all i of the geometric distances between the point i and the point i+1. The contour of N points sampled is considered a closed loop so that the first point is equivalent to the N+1 point. From block 208, the microprocessor 176 proceeds to block 209 where l is checked against a threshold. If l is less than the threshold then the image is rejected at block 211 and the microprocessor 176 begins analyzing the next image by returning to block 14 of FIG. 3 and again proceeding to block 200. If l is greater than the threshold then the microprocessor 176 proceeds to block 210 to determine whether dl is greater than a threshold. If dl is greater than the threshold, then the microprocessor 176 proceeds from block 210 to block 206. At block 206, the microprocessor 176 determines if a point, i, is too close to the point i+1. If so, then the point i is removed from the set. If the point i is too far away from the point i+1, then the microprocessor 176 inserts a new point at mid-distance between the points i and i+1. From block 206, the microprocessor 176 proceeds to block 205 to calculate the forces for the filter points determined at block 206. If, dl is less than the threshold as determined by the microprocessor at block 210, then the microprocessor 176 proceeds to block 212 to fix the position of the contour by storing the position of all of the points that are set. When this happens, the image is determined to be of sufficient quality to be analyzed for disk detection at blocks 15 and 16 according to the ellipse fitting method described in detail below. It is noted, that the disk detection may use seed points for finding the center of the optic disk as discussed below. Alternatively, however, the contour which is fixed at block 212 may also be used as a starting point for finding and fitting an ellipse to the image of the optic disk that is captured in a particular frame.

Returning to FIG. 3, at block 15, the microprocessor analyzes the bit mapped image data representing the first frame of a captured image, i.e. frame 0, to find the optic disk. If the optic disk cannot be found at block 15, the captured image is determined to be insufficient to provide identification data and the microprocessor returns to block 14 to cause the camera 122 to capture another image of the retina.

Other tests to determine the sufficiency of the captured image to provide identification data may be performed at block 15 in lieu of finding the optic disk or in addition thereto. For example, the microprocessor 176 may process the image data to detect reflections. If reflections are detected, the image is determined to be insufficient to provide the identification data and the microprocessor returns to block 14 to cause another image to be captured. Another test for determining whether an image is sufficient to provide identification data may include finding the optic disk and comparing one or more characteristics of the optic disk to a respective threshold or boundary. If the characteristic of the optic disk is outside of the threshold or boundary, the image is determined to be insufficient. In accordance with this method, the size of the optic disk, for example, is compared to one or more size boundaries to determine if the detected disk is too large or too small. If the detected disk is found to be too big or too small the captured image is determined to be insufficient. Another characteristic of the optic disk that may be analyzed to determine the sufficiency of the captured image is the edge strength. In this embodiment, the edge strength about the optic disk is analyzed to determine if it is generally consistent. If the edge strength of the optic disk is determined to be inconsistent wherein for example, the edge strength of one side of the optic disk is very strong whereas another side of the optic disk is very weak or not detected, the captured image is determined to be insufficient and the microprocessor returns to block 14. Still another characteristic of the optic disk that may be analyzed is the shape of the optic disk. For example, if the optic disk is determined to be too elliptical rather than only slightly elliptical as would be expected for the optic disk, then the captured image is determined to be insufficient to provide the identification data and the microprocessor returns to block 14 to capture another image. A further method for determining the sufficiency of the image includes comparing the intensity of the pixels in the shaded area between the boundaries 75 and 79 to the intensity of the pixels in the shaded area between the boundaries 75 and 77 to see if they are too similar or too different indicating an image of insufficient quality. Another method for testing the sufficiency of the image includes determining an initial estimate of the center of the optic disk as discussed below. If the initial estimate of the center of the optic disk is too far from the mathematical center of the found disk or is too close to the edge of the image, the image is determined to be insufficient. Further, a determination can be made as to whether the initial estimate of the center of the optic disk is actually within the boundary of the optic disk or outside thereof. If the estimated center is outside of the boundary, the image is determined to be insufficient and the microprocessor returns to block 14 to capture another image. Further, if there is a significant difference between the cost function B as calculated in each frame, then the image may be determined to be insufficient.

Another test for determining the sufficiency of the captured image may be implemented at blocks 16 and 17 for the embodiment of the present invention where multiple frames or N frames of an image are captured at block 14. In particular, at block 16, the microprocessor 176 detects the optic disk in each of N frames of the image. As the disk is detected in each of the frames or after the disk has been detected in all of the frames, the microprocessor 176 aligns the images of the respective frames so as to superimpose multiple frames of the image at block 17. In order to align or superimpose N frame images, the microprocessor 176 first finds the optic disk in the first frame, i.e. frame 0. Next, the microprocessor measures the translation between the first frame and a subsequent frame wherein the translation is the change in location and/or shape of the optic disk. The microprocessor 176 then applies the measured translation to subsequent frames so that the translated, subsequent frame is aligned or superimposed on the first frame. The step of measuring the translation and applying the translation so as to superimpose a frame is repeated for all the subsequent frames to align or superimpose the N frames. If N frames cannot be aligned then the captured image is determined to be insufficient and the microprocessor 176 returns to block 14 to capture another image.

More particularly, in order to align N frames of a captured image, N frames of digitized, bit map images of the retina are captured at block 14 and stored in a memory associated with the microprocessor 176 as N separate bit map images. Thereafter, the microprocessor 176 finds the location of the optic disk and the first bit map image, i.e. frame 0. Next, the ellipse parameters x, y, a, b and θ are determined as discussed below and stored in the microprocessor's memory. A cost function B is calculated, for example as discussed below at block 66, starting with the ellipse parameters for the first bit map image. Next, the microprocessor 176 searches left, right and up, down, i.e. x1+1, x1−1, y1+1, and y1−1 for the maximum increase in the cost function B until the maximum B is found. New values of x and y are stored as xi and yi where i is an index of the ith bitmap. Next, starting from xi and yi and using the determined a, b and θ parameters, the microprocessor 176 calculates a cost function B using the next bit map and repeats the steps of searching for the maximum increase in the cost function B until the maximum B is found and storing the new values of x and y as xi and yi until all N bit maps have been considered. Then the microprocessor 176 calculates translation values dxi and dyi where dxi is the displacement in x for the bit map i and dyi is the displacement in y for the bit map i for each bit map. Specifically, dxi is set equal to xi−x1 and dyi is set equal to yi−y1. Thereafter, the microprocessor 176 translates pixel values in each image according to the translation values dxi and dyi to align the frame images. If the microprocessor 176 is not able to align the frames of the captured image because there is too much translation between the N frames of the image, then the microprocessor 176 determines that the image is insufficient to provide identification data and returns to block 14 to capture another image. Further, if there is a significant difference between the cost function B as calculated in each frame, then the image may be determined to be insufficient.

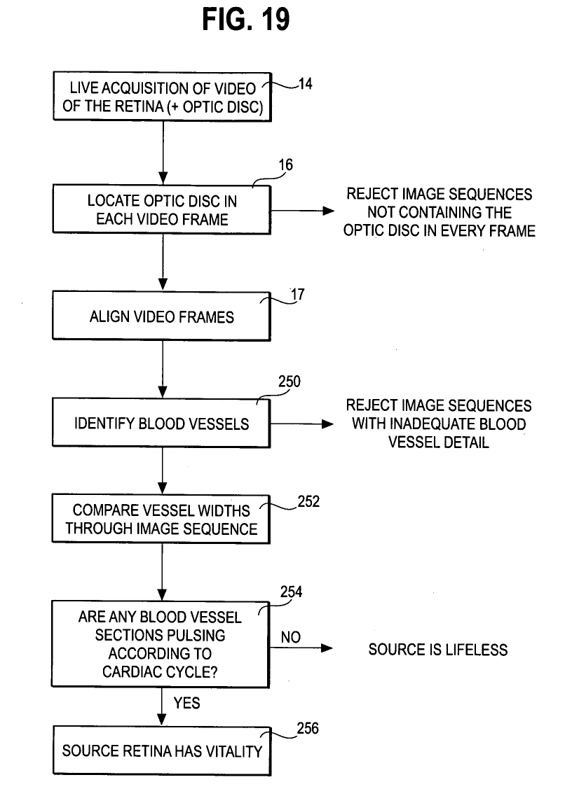

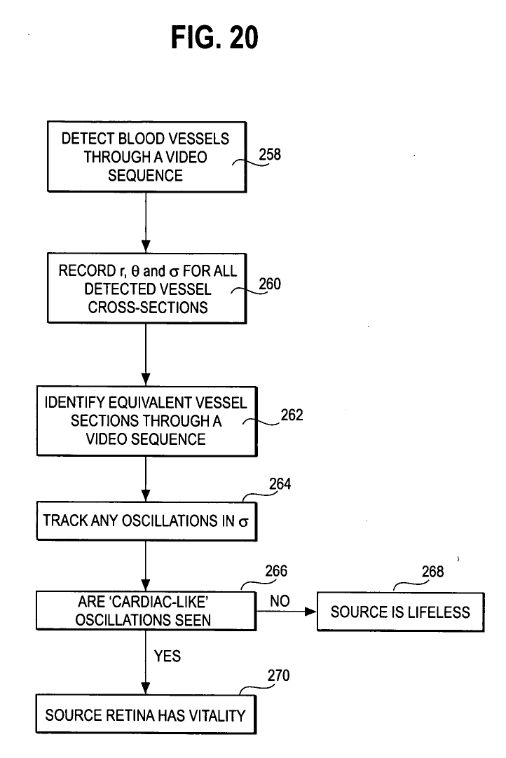

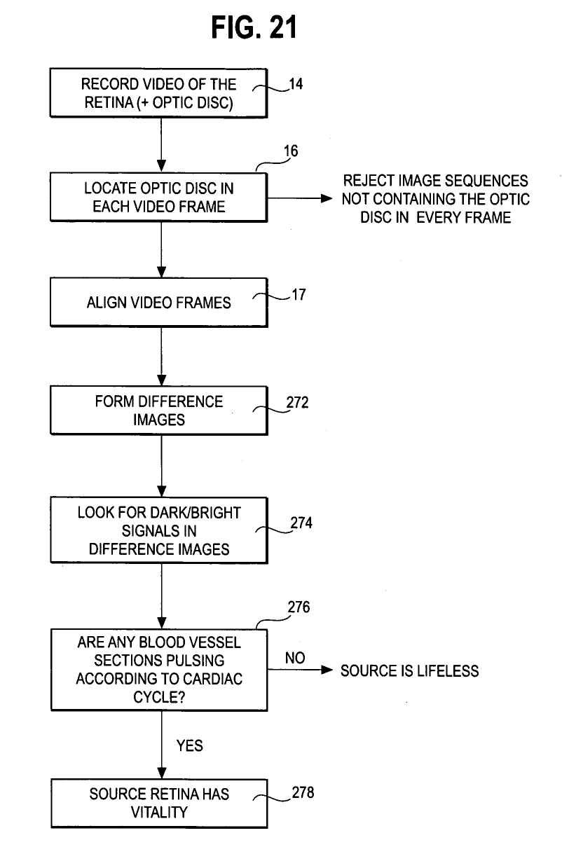

The microprocessor 176, after aligning the N frames at block 17, proceeds to block 19 to detect a vessel pattern in the retina with respect to the optic disk and to generate identification data as discussed in detail below. Before generating the identification data, however, the microprocessor can proceed to bock 250 of FIG. 19 or block 272 of FIG. 21 to determine whether the sequence of captured images is from a living source or not. It is noted, that the methods of FIGS. 19 and 20 for determining whether a biometric is from a living source can be performed after the identification data is generated as well.

More particularly, as shown in FIG. 19, and as discussed above, after acquiring a sequence of images of the retina, preferably including the optic disk as represented by bit mapped digital data, the microprocessor 176 proceeds to block 16 to locate the optic disk in each of the video image frames that have been captured. If a captured image is not sufficient for analysis, for example, the image frame does not contain the optic disk, the microprocessor 176 rejects that insufficient image so that it is no longer part of the sequence of images captured. From block 16, the microprocessor 176 proceeds to block 17 to align the successive images in the sequence of image frames as discussed above. Thereafter, at block 250, the microprocessor 176 identifies one or more blood vessels contained in each of the sequence of captured images. At block 252, the microprocessor 176 compares the width of a given blood vessel in each of the sequence of images so as to determine at block 254 whether that blood vessel is pulsing according to a cardiac cycle. If the microprocessor 176 determines that the blood vessel is pulsing according to a cardiac cycle, the microprocessor determines at block 256 that the source of the captured image is a living source. Otherwise, the microprocessor 176 determines that the source of the captured images is lifeless. Details of the steps performed by the microprocessor 176 at blocks 252 and 254 are described with reference to FIG. 20 below.

In an alternate embodiment of the system and method for determining whether the captured retinal images are from a living source or not is shown in FIG. 21. As in FIG. 19, the microprocessor 176 captures a sequence of images of the retina, locates the optic disk in each image of the sequence and aligns the captured images determined to be sufficient for analysis at the respective blocks 14, 16 and 17 of FIG. 21. Thereafter, at block 272, the microprocessor 176 calculates the differences in pixel intensities from the frame i to the frame i+1 throughout the sequence of images. This calculation forms difference images representing the difference between successive images in the sequence of captured image frames. A pulsing blood vessel can then be located and characterized by analyzing the differences. For example, through the sequence of difference images, a pulsing blood vessel can be see as a dark-bright-dark pulsing echo on either side of the blood vessel. The microprocessor 176 looks for these dark-bright-dark echo signals/images in each of the difference images calculated at block 272. It is noted that due to the alignment of the images in the sequence of captured image frames at block 17, very little other detail is seen in the difference images calculated at block 272. The presence of dark-bright-dark echoes indicate the presence of a pulsing blood vessel. If the sequence of the echoes matches that expected for a cardiac cycle as determined by the microprocessor 176 at block 276, then the microprocessor 176 determines at block 278 that the source of the captured sequence of images is a living source. Otherwise, the source of the captured images is determined to be lifeless. It is noted that with regard to either of the methods of FIG. 19 or 21, instead of using the optic disk as a common reference to align the video frames, the method can use a major blood vessel for example. In such an embodiment, the images captured in the sequence at block 14 are such that the major blood vessel is captured at block 14 and located in each of the video frames at block 16. If the major blood vessel is not located in a particular video image of the sequence of image frames, that image is rejected and no longer part of the sequence of captured images. Thereafter, at block 17, the microprocessor 176 would align the video frames with respect to the major blood vessel.

FIG. 4 illustrates one embodiment of a method for finding the location of the optic disk in an image of the retina. In accordance with this method, an estimated location of the center of the optic disk in the image, as represented by the pixel data, is obtained by identifying the mean or average position of a concentrated group of pixels having the highest intensity. It is noted that the method of the present invention as depicted in FIGS. 4-7 and 9 can be implemented by a computer or processor.

More particularly, as shown at block 20, a histogram of the pixel intensities is first calculated by the processor for a received retinal image. Thereafter, at block 22, the processor calculates an intensity threshold where the threshold is set to a value so that 1% of the pixels in the received image have a higher intensity than the threshold, T. At block 22, the processor assigns those pixels having an intensity greater than the threshold T to a set S. Thereafter, at block 24, the processor calculates, for the pixels assigned to the set S, the variance in the pixel's position or location within the image as represented by the pixel data. The variance calculated at block 24 indicates whether the highest intensity pixels as identified at block 22 are concentrated in a group as would be the case for a good retinal image. If the highest intensity pixels are spread throughout the image, then the image may contain unwanted reflections. At block 26, the processor determines if the variance calculated at block 24 is above a threshold value and if so, the processor proceeds to block 28 to repeat the steps beginning at block 22 for a different threshold value. For example, the new threshold value T might be set so that 0.5% of the pixels have a higher intensity than the threshold or so that 1.5% of the pixels have a higher intensity than the threshold. It is noted that instead of calculating a threshold T at step 22, the threshold can be set to a predetermined value based on typical pixel intensity data for a retinal image. If the variance calculated at block 24 is not above the variance threshold as determined at block 26, the processor proceeds to block 30 to calculate the x and y image coordinates associated with the mean or average position of the pixels assigned to the set S. At block 32, the x, y coordinates determined at block 30 become an estimate of the position of the center of the optic disk in the image.

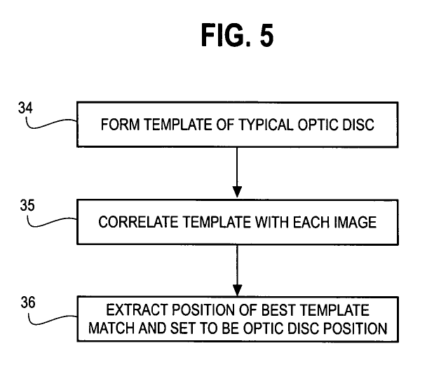

An alternative method of finding the optic disk could utilize a cluster algorithm to classify pixels within the set S into different distributions. One distribution would then be identified as a best match to the position of the optic disk on the image. A further alternative method for finding the optic disk is illustrated in FIG. 5. In accordance with this method, a template of a typical optic disk is formed as depicted at block 34. Possible disk templates include a bright disk, a bright disk with a dark vertical bar and a bright disk with a dark background. The disk size for each of these templates is set to a size of a typical optic disk. At block 35, the template is correlated with the image represented by the received data and at block 36, the position of the best template match is extracted. The position of the optic disk in the image is then set equal to the position of the best template match It should be apparent, that various other signal processing techniques can be used to identify the position of the optic disk in the image as well.

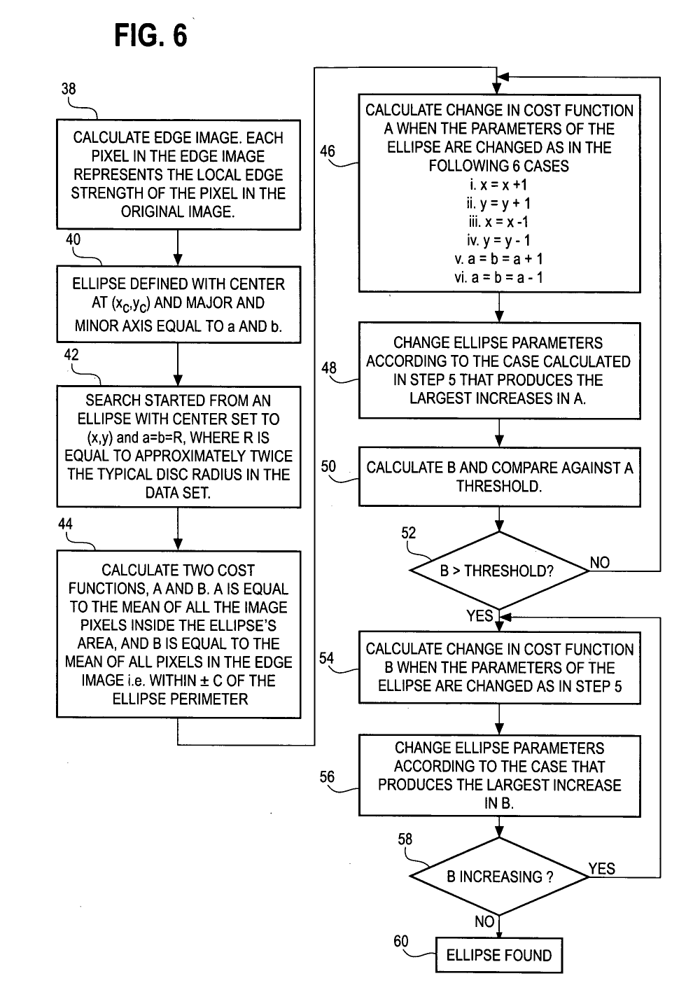

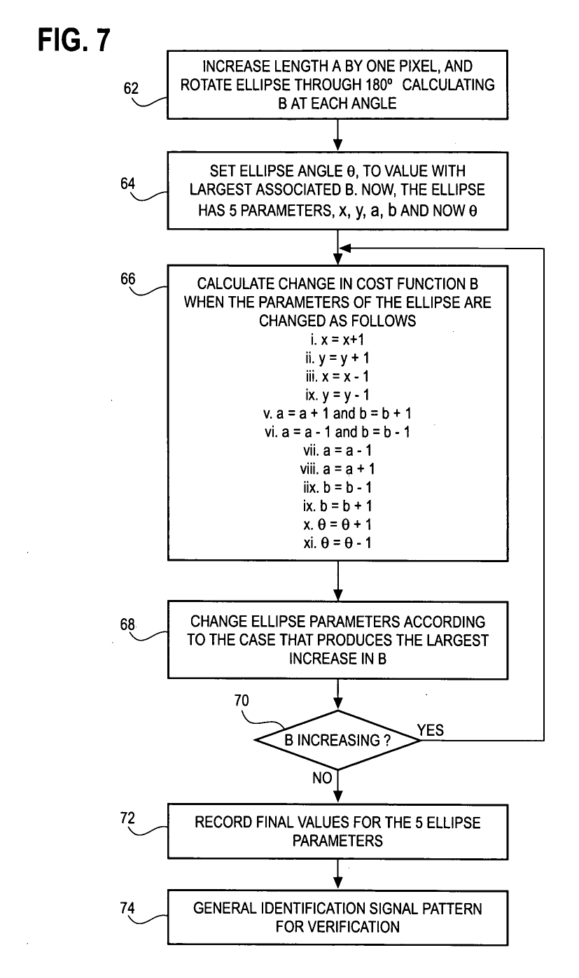

After locating the optic disk, the boundary of the disk is found by determining a contour approximating a shape of the optic disk. The shape of a typical optic disk is generally an ellipse. Since a circle is a special type of ellipse in which the length of the major axis is equal to the length of the minor axis, the method first finds the closest fitting circle to the optic disk as shown in FIG. 6. The method then distorts the closest fitting circle into an ellipse, as depicted in FIG. 7, to find a better match for the shape of the optic disk in the received image.

The algorithm depicted in FIG. 6 fits a circle onto the image of the optic disk based on an average intensity of the pixels within the circle and the average edge strength of the pixels about the circumference of the circle, i.e. within the boundary area 14, as the circle is being fit. More particularly, as shown at block 38, the processor first calculates an edge strength for each of the pixels forming the image. Each pixel in the retinal image has an associated edge strength or edge response value that is based on the difference in the intensities of the pixel and its adjacent pixels. The edge strength for each pixel is calculated using standard, known image processing techniques. These edge strength values form an edge image.

At block 40, an ellipse is defined having a center located at the coordinates x_{c} and y_{c} within the bit mapped image and a major axis length set equal to a and a minor axis length set equal to b. At block 42, the search for the closest fitting circle starts by setting the center of the ellipse defined at block 40 equal to the estimated location of the center of the optic disk determined at block 32 of FIG. 4. At block 42, the major axis a and the minor axis b are set equal to the same value R to define a circle with radius R, where R is two times a typical optic disk radius. It is noted that other values for the starting radius of the circle may be used as well. At block 44, a pair of cost functions, A and B are calculated. The cost function A is equal to the mean or average intensity of the pixels within the area of an ellipse, in this case the circle defined by the parameters set at block 42. The cost function B is equal to the mean or average edge strength of the pixels within a predetermined distance of the perimeter of an ellipse, again, in this case the circle defined at block 42.

At block 46, the processor calculates the change in the cost function A for each of the following six cases of parameter changes for the ellipse circle: (1) x=x+1; (2) y=y+1; (3) x=×1; (4) y=y−1; (5) a=b=a+1; (6) a=b=a−1. At block 48, the processor changes the parameter of the circle according to the case that produced the largest increase in the cost function A as determined at block 46. For example, if the greatest increase in the cost function A was calculated for a circle in which the radius was decreased by 1, then at block 48, the radius is set to a=b=a−1 and the coordinates of the center remain the same. At block 50, a new value is calculated for the cost function B for the circle defined at block 48. At block 52, the processor determines whether the cost function value B calculated at block 50 exceeds a threshold. If not, the processor proceeds back to block 46 to calculate the change in the cost function A when each of the parameters of the circle defined at block 48 are changed in accordance with the six cases discussed above.

When the cost function B calculated for a set of circle parameters exceeds the threshold as determined at block 52, this indicates that part of the circle has found an edge of the optic disk and the algorithm proceeds to block 54. At block 54, the processor calculates the change in the cost function B when the parameters of the circle are changed for each of the cases depicted in step 5 at block 46. At block 56, the processor changes the ellipse pattern according to the case that produced the largest increase in the cost function B as calculated at step 54. At block 58, the processor determines whether the cost function B is increasing and if so, the processor returns to block 54. When the cost function B, which is the average edge strength of the pixels within the boundary area 14 of the circle being fit onto the optic disk, no longer increases, then the processor determines at block 60 that the closest fitting circle has been found.

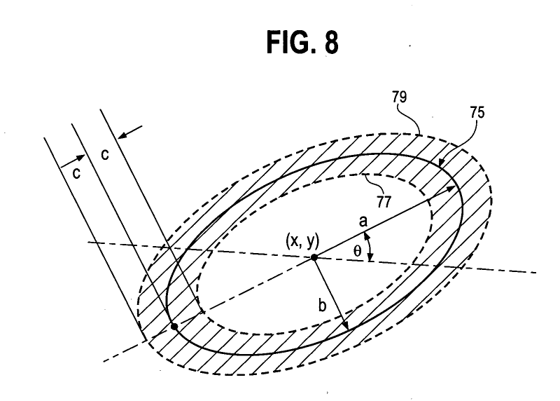

After finding the closest fitting circle, the method of the invention distorts the circle into an ellipse more closely matching the shape of the optic disk in accordance with the flow chart depicted in FIG. 7. At block 62 of FIG. 7, the length of the major axis a is increased by a variable S number of pixels and the length of the minor axis b can be decreased by the same or different number of pixels. This ellipse is then rotated through 180° from a horizontal axis and the cost function B is calculated for the ellipse at each angle. At block 64, the processor sets the angle 0 of the ellipse, as shown in FIG. 8, to the angle associated with the largest cost function B determined at block 62. FIG. 8 illustrates the five parameters defining the ellipse: x, y, a, b and S. Also shown in FIG. 8 is the edge area or boundary area 14 for which the cost function B is calculated wherein the area 14 is within +c of the perimeter of the ellipse. A typical value for parameter c is 5, although other values may be used as well.

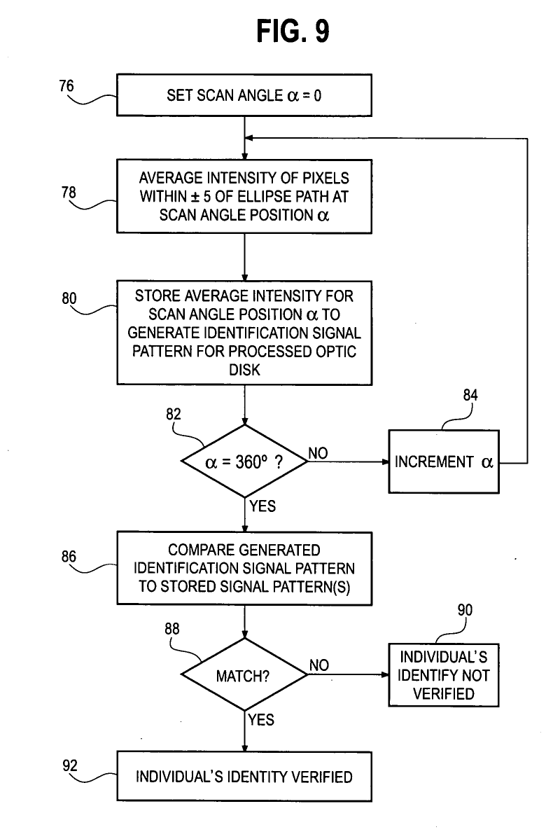

At block 66, the processor calculates the change in the cost function B when the parameters of the ellipse are changed by S as follows:
(1) x=x+S
(2) y=y+S
(3) x=x−S
(4) y=y−S
(5) a=a+S and b=b+S
(6) a=a−S and b=b−S
(7) a=a−S
(8) a=a+S
(9) b=b−S
(10) b=b+S
(11) θ=θ+S
(12) θ=θ−S
   It is noted that θ need not be changed by the same value of S. At block 68, the processor changes the ellipse parameter that produces the largest increase in the cost function B as determined at block 66 to fit the ellipse onto the optic disk image. Steps 66 and 68 are repeated until it is determined at block 70 that the cost function B is no longer increasing. At this point the processor proceeds to block 72 to store the final values for the five parameters defining the ellipse fit onto the image of the optic disk as represented by the pixel data. The ellipse parameters determine the location of the pixel data in the bit mapped image representing the elliptical boundary 18 of the optic disk in the image as illustrated in FIGS. 1, 2 and 3 and the elliptical optic disk boundary 75 shown in FIG. 9. This process is performed for each of the image frames being analyzed. The processor proceeds from block 72 to block 74 to generate a signal pattern to identify the individual from pixel data having a predetermined relationship to the boundary 18, 75 of the optic disk found at block 72. This step is described in detail for one embodiment of the present invention with respect to FIGS. 8 and 9.

The method depicted in FIG. 9 generates the signal pattern identifying the individual from the pixel intensity data within a boundary area 14 defined by a pair of ellipses 77 and 79 which have a predetermined relationship to the determined optic disk boundary 75 as shown in FIG. 8. Specifically, each of the ellipses 77 and 79 is concentric with the optic disk boundary 75 and the ellipse boundary 77 is −c pixels from the optic disk boundary 75; whereas the ellipse boundary 79 is +c pixels from the optic disk boundary 75. In accordance with the method of generating the signal pattern as shown in FIG. 9, the processor at block 76 sets a scan angle α to 0. At block 78, the processor calculates the average intensity of the pixels within ±c of the ellipse path defined at block 72 for the scan angle α. As an example c is shown at block 78 to be set to 5 pixels. At block 80, the processor stores the average intensity calculated at block 78 for the scan angle position α to form a portion of the signal pattern that will identify the individual whose optic disk image was analyzed. At block 82, the processor determines whether the angle α has been scanned through 360°, and if not, proceeds to block 84 to increment α. The processor then returns to block 78 to determine the average intensity of the pixels within ±c of the ellipse path for this next scan angle α. When α=360°, the series of average pixel intensities calculated and stored for each scan angle position from 0 through 360° form a signal pattern used to identify the processed optic disk image. This generated signal pattern is then compared at block 86 to a signal pattern stored for the individual, or to a number of signal patterns stored for different individuals, to determine if there is a match. If a match is determined at block 88, the individual's identity is verified at block 92. If the generated signal pattern does not match a stored signal pattern associated with a particular individual, the identity of the individual whose optic disk image was processed is not verified as indicated at block 90.

In another embodiment of the present invention, as illustrated in FIG. 2, the boundary area 14, from which the signal pattern identifying the individual is generated, is defined by the optic disk boundary 18 determined at block 72 and a concentric ellipse 16 having major and minor axes that are a given percentage of the length of the respective major and minor axes a and b of the ellipse 18. For example, as shown in FIG. 2, the length of the major and minor axes of the ellipse 16 are 70% of the length of the respective major and minor axes of the ellipse 18. It should be appreciated that other percentages can be used as well including percentages greater than 100% as well as percentages that are less than 100%. Once the boundary area 14 is defined, the signal pattern can be generated by calculating the average intensity of the pixels within the boundary area 14 at various scan angle position a as discussed above.

FIG. 10 illustrates the signal patterns 94 and 96 generated from two different images of the same individual's retina where the images were taken several months apart. As can be seen from the two signals 94 and 96, the signal pattern generated from the two different images closely match. Thus, the method of the present invention provides a unique signal pattern for an individual from pixel intensity data representing an image of a portion of the optic disk where a matching or consistent signal pattern is generated from different images of the same individual's retina. Consistent signal patterns are generated for images having different quality levels so that the present invention provides a robust method for verifying the identity of an individual. FIG. 11 illustrates a signal pattern generated for a different individual from the image of FIG. 3.

The signal pattern generated in accordance with the embodiments discussed above represents the intensity of pixels within a predetermined distance of the optic disk boundary 75. It should be appreciated, however, that a signal pattern can be generated having other predetermined relationships with respect to the boundary of the optic disk as well. For example, in another embodiment of the invention, the signal pattern is generated from the average intensity of pixels taken along or with respect to one or more predetermined paths within the optic disk boundary or outside of the optic disk boundary. It is noted that these paths do not have to be elliptical, closed loops or concentric with the determined optic disk boundary. The paths should, however, have a predetermined relationship with the optic disk boundary to produce consistent signal patterns from different retinal images captured for the same individual. In another embodiment, the area within the optic disk boundary is divided into a number of sectors and the average intensity of the pixels within each of the sectors is used to form a signal pattern to identify an individual. These are just a few examples of different methods of generating a signal pattern having a predetermined relationship with respect to the boundary of the optic disk found in accordance with the flow charts depicted in FIGS. 6 and 7.

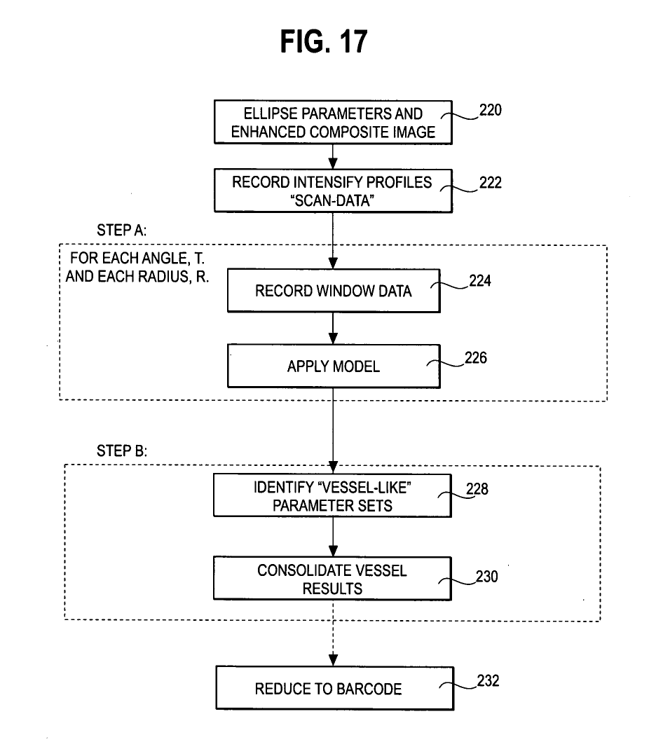

Further, a signal pattern can be generated by detecting a vessel pattern as shown in FIG. 17. As depicted at block 220, the vessel detection method uses the boundary of the optic disk described by the ellipse parameters cx, cy, a, b and θ found by the algorithm described above. At block 222, the vessel detection method utilizes scan data that is stored for example in a text file. The scan data may be the pixel values from the enhanced, composite image as recorded along concentric ellipses at various radii, for example, 70%, 74% . . . 120% . . . , of the ellipse that was fitted to the boundary of the optic disk. Along the circumference of the ellipse, the data is sampled at various radii and at various angles. Alternatively, the scan data may be recorded by first polar unwrapping the data within an annulus defined by the optic disc into a rectangular ‘polar unwrapped’ image as follows. First, an inner and an outer elliptic boundaries are defined where the inner ellipse has parameters, (cx, cy, theta, s*a and s*b) and the outer ellipse has parameters, (cx, cy, theta, S*a and S*b), where cx, cy, theta, a and b are the same as the parameters of the ellipse fitted to the boundary of the optic disc and s and S are multiplicative factors, for example s=0.7 and S=1.2. These inner and outer ellipses form the boundaries encompassing an annulus. These elliptic boundaries are each divided into N angular sections. The annulus is thus divided into N angular samples. Each angular sample is divided into M radial samples. The annulus is thus sampled into (M×N) sections. The centers of each section form M×N coordinates. Intensity values are calculated for each coordinate using a two-dimensional bilinear approximation of pixels values in the neighborhood of each coordinate from the enhanced, composite image. The (M×N) derived intensity values form a polar unwrapped image representing the original image data within the annulus. The x dimension of the polar unwrapped image represents the index number of the angular sample of the annulus whereas the y dimension represents the index of the radial sample of the annulus. In this way the x-index represents the angle from the centre of the optic disc and the y-index represents the radial distance from the centre of the optic disc. Scan data is then derived from the polar unwrapped image using intensity values recorded along rows, or averaging numbers of rows, to form one-dimensional scan data.

The scan data is denoted by two variables, the pixel's angle and which radius specific scan it is within. A method is then used to locate blood vessels along each scan, i.e. radius, that is applied. This method includes two steps. The first step, implemented at blocks 224 and 226, fits a five parameter model to the intensity profile of the scan and records the results for every angle. The second step, implemented at blocks 228 and 230, records instances of vessels by analysis of the local model parameters. More specifically, at block 224, the microprocessor 176 records window data. That is, for each and every angle, t, along each scan radii, a window of intensity values centered on t is recorded. These intensity values become the local data for the application of the model-fitting method implemented at block 226. For example, a Levenberg-Marquardt method can be used at block 226 to fit a non-linear five-parameter model to the data in the window. The model is constructed from the addition of a one-dimensional Gaussian curve that is used to approximate the profile of a blood vessel and a straight line that is used to approximate the local gradient of the intensity within the image. The five parameters are as follows:
p₁=Amplitude of Gaussian
p₂=Position of Gaussian
p₃=Gaussian's variance
p₄=Gradient of straight line
p₅=Intercept of straight line.

The model function is:
y=p₁*exp[−(x−p₂)²/(p₃)²]+p₄*x+p₅.
The parameters are set to initial default values with p₂ set to t, and the Levenberg-Marquardt method is used to best fit this function to the data and the five parameters are recorded for each angle, t, in each scan. An example of a result is shown in FIG. 13.

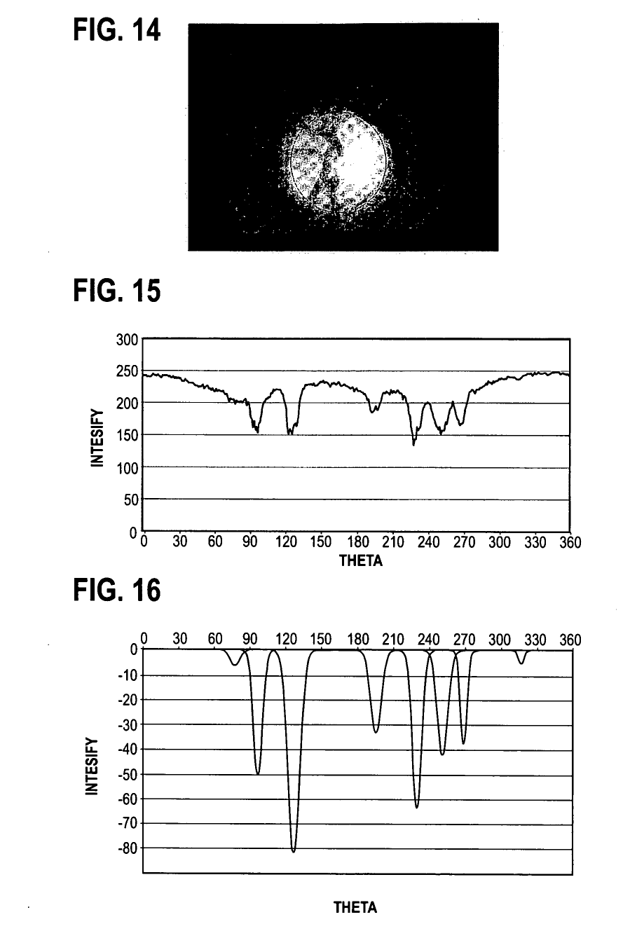

The second step in the vessel detection method includes identifying vessel-like parameter sets at block 228. In this step, a function is used to record sets of parameters that could represent blood vessels, i.e. those for which the parameters fall within defined tolerances. The remaining parameter sets are considered as candidate vessel-results. If these possible vessel-results match the results for neighboring angles, then an incident of a vessel is recorded at the current angle and is represented by the five parameters. The recorded parameters can be a particular combination of those recorded at a particular angle and those recorded at neighboring values such that repeat detection of a single vessel is consolidated into a single record at block 230. All detected vessels are then recorded for all of the radius-specific-scans for each image. By applying these steps at all angles within a radius-specific-scan, a picture of the vessel pattern is recorded in the form of sets of the five parameters. For example, FIG. 14 shows and example of an enhanced composite image of an optic disk with the boundary of the disk located within an ellipse; FIG. 15 shows the corresponding intensity profile recorded as a function of angle along the circumference of a radius-specific-scan; and FIG. 16 shows the recorded vessel pattern reconstructed in terms of the model and the recorded parameters, p₁, p₂ and p₃ wherein p₄ and p₅ are not shown. Once the vessel detection process is completed it possible to reduce the data further into the form of a barcode at block 232 by thresholding the Gaussian widths and reducing the angles θ to vessel present, represented by a 1 bit, and to vessel not present, represented by a 0 bit.

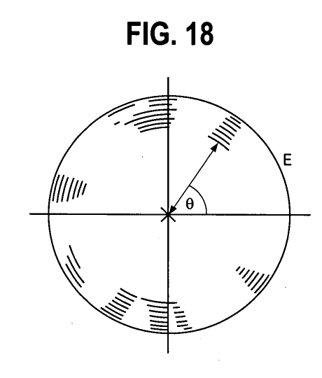

As discussed above, each detected retinal blood vessel cross section is characterized by a one dimensional model containing five parameters p₁, p₂, p₃, p₄ and p₅ where the model function is
y=p₁*exp[−(x−p₂)²/(p₃)²]+p₄*x+p₅.
In order to determine whether the captured images of a sequence are from a living source or not as discussed above with respect to FIG. 19, the blood vessels are thus detected in each image of the sequence of images captured as shown at block 258 in FIG. 20. From the model function defining the blood vessel cross section, it is possible to reduce the number of parameters used to represent a blood vessel cross section to three parameters, r, θ, and σ, for use in the method of detecting whether the captured images are from living source or not as depicted in FIG. 19. Specifically, r can be set equal to the radius of an ellipse, concentric with the ellipse E bounding the optic disk as shown in FIG. 18. Second, θ is the angle between the radius r and a horizontal axis where the radius r and the horizontal axis intersect at the center point of the ellipse that bounds the optic disk, and where θ=p₂. The third parameter a represents the detected width of the blood vessel. This is derived from the parameter p₃, which in one embodiment is given by the following equation.
σ=|p₃|.
Therefore, the position of the centre of each detected blood vessel cross-section is represented by r and θ, and its width is represented by σ. In this way each detected vessel cross-section is represented by the triplet (r, θ, σ).

As shown in the liveness detection method of FIG. 20, the microprocessor 176 first detects one or more blood vessels in the images of a capture sequence at block 259. The microprocessor 176 then determines and records at block 260 the three parameters r, θ and α for one or more of the blood vessels in an image. Thereafter, at block 262 the microprocessor 176 identifies the same blood vessel sections in each of the other images in the sequence of captured images and records the corresponding parameters r, θ, and α for the corresponding or equivalent blood vessel sections. Equivalent blood vessel cross-sections are tracked through the sequence of captured image frames by comparing r and θ values for each video frame because their values only vary by small experimental errors. Suppose (rᵢ, θᵢ, σᵢ) is a result triplet from the i^{th} frame in a video sequence and (rⱼ, θⱼ, σⱼ) is a result triplet from the j^{th} frame. If Δr and Δθ are the maximum expected experimental errors in the values of r and θ respectively, then if
|rⱼ−rᵢ|<Δr and |θⱼ−θᵢ|<Δθ,
the two triplets are said to correspond to the same blood vessel cross-section. If this is the case then Δσᵢⱼ, describes the change is width of the blood vessel cross-section from the i^{th} frame to the j^{th} frame.
Δσᵢⱼ=(σⱼ−σᵢ).
Δσ can then be calculated through a sequence of video frames. At block 264, the microprocessor 176 compares the blood vessel width of the identified blood vessel section in each of the images of the sequence and tracks any changes in the width of the blood vessel section so as to determine whether the width is oscillating or not. At block 266, the microprocessor 176 determines whether there are any cardiac like oscillations in the widths of a given blood vessel section that is tracked and recorded at block 264. For example, if Δσ oscillates from negative to positive at a regular rate between upper and lower bounds where the upper and lower bounds are chosen to reflect the range in expected heart rates of the user, then the change in width indicates cardiac like oscillations and a pulsing blood vessel. If cardiac like oscillations in the width of a blood vessel section are detected, the microprocessor 176 determines at block 270 that the source of the captured images is from a living source. If no oscillations in the width of the identified blood vessel section are seen or if oscillations are seen but they are not typical of a cardiac cycle, the source of the captured images is determined to be lifeless at block 268. It is noted that the method of FIGS. 19 and 20 can be applied to the main or central artery once this blood vessel is identified or to any other blood vessel. Alternatively, this method can be applied to a network of detected blood vessels, i.e. two or more blood vessels that are common in each of the captured sequence of images.

An alternative to the above method could only identify a source retina as having signs of vitality if a longer section of one blood vessel is found to have cardiac induced oscillations in its width. Here the section of blood vessel is represented by a number of triplets representing different blood vessel sections along the length of the blood vessel:
[(r₁,θ₁,σ₁),(r₂,θ₂,σ₂), . . . (rₙ,θₙ,σₙ)]
as shown diagrammatically in FIG. 18 where the white lines bound the represented blood vessel section. This set of triplets can be identified at describing the same blood vessel because there is either a very small change in θ or a near linear change in θ with increasing r. If the ah values of the triplets in the set exhibit the same cardiac induced oscillations then this section of blood vessel is identified as pulsing.

Many modifications and variations of the present invention are possible in light of the above teachings. For example, the attribute that is analyzed to determine whether captured images are from a living source may be other than the width or pixel intensity associated with a blood vessel as discussed above. The attribute that is analyzed may include the absorption or reflectivity of different wavelengths of light. The attribute that is analyzed may also include, Saccadic movements of the eye which are characterized by rapid intermittent motion. If such Saccadic movements of the eye are detected, this indicates that the source of the captured images is living. Moreover, larger eye movement can be used as well. The system of the present invention can cause the eye to focus on a moving target, for example wherein the system tracks the controlled movement of the eye as it follows the target. Therefore, another attribute that can be analyzed to determine whether the source of the captured image is living or not is controlled eye movement. It should be apparent that other attributes of a living source can be used as well. Thus, it is to be understood that, within the scope of the appended claims, the invention may be practiced otherwise than as described hereinabove.

What is claimed and desired to be secured by Letters Patent is:

1. A method of detecting whether a biometric is from a living source comprising:
capturing a sequence of images of a biometric wherein the images are represented by image data and the biometric images in the sequence include at least one common blood vessel;
determining the widths of the common blood vessel in the captured images of the sequence from the biometric data associated with the respective images; and
comparing the determined widths of the common blood vessel in the captured images of the sequence to determine whether the captured images are from a living source.

2. A method of detecting whether a biometric is from a living source as recited in claim 1 wherein the biometric is an eye.

3. A method of detecting whether a biometric is from a living source as recited in claim 1 wherein the biometric is a retina of an eye.

4. A method of detecting whether a biometric is from a living source as recited in claim 3 wherein the captured images of the sequence include the optic disk and the method includes:
locating the optic disk in the captured images from the image data;
locating a common blood vessel in the captured images of the sequence with reference to the optic disk from the associated image data.

5. A method of detecting whether a biometric is from a living source as recited in claim 1 wherein the method includes aligning the sequence of images with respect to a common reference.

6. A method of detecting whether a biometric is from a living source as recited in claim 1 wherein the determined widths of the common blood vessel are compared to determine whether the blood vessel is pulsing.

7. A method of detecting whether a biometric is from a living source as recited in claim 1 wherein the determined widths of the common blood vessel are compared to determine whether the width of the blood vessel is oscillating in a manner expected in a cardiac cycle.

8. A method of detecting whether captured images of an eye are from a living source comprising:
capturing a sequence of images of an eye wherein the images are represented by image data and the images in the sequence include at least one blood vessel;
locating the same blood vessel in the images of the sequence from the image data; and
determining from the image data associated with the respective images in the sequence whether the located blood vessel is pulsing to detect whether the captured images of the eye are from a living source.

9. A method of detecting whether a biometric is from a living source as recited in claim 8 wherein the captured images are images of a retina of the eye.

10. A method of detecting whether captured images of an eye are from a living source as recited in claim 9 wherein the captured images of the sequence include the optic disk and the method includes:
locating the optic disk in the captured images from the biometric data;
locating a common blood vessel in the captured images of the sequence with reference to the optic disk from the associated biometric data.

11. A method of detecting whether captured images of an eye are from a living source as recited in claim 8 wherein the method includes aligning the sequence of images with respect to a common reference.

12. A method of detecting whether captured images of an eye are from a living source as recited in claim 11 wherein the common reference is the optic disk.

13. A method of detecting whether captured images of an eye are from a living source as recited in claim 8 wherein the step of determining whether the located blood vessel is pulsing includes determining the width of the located blood vessel in the sequence of captured images; and determining whether there is a variation in the widths of the located blood vessel representative of a pulsing blood vessel in a living source.

14. A method of detecting whether captured images of an eye are from a living source as recited in claim 8 wherein the step of determining from the image data associated with the respective images in the sequence whether the located blood vessel is pulsing includes analyzing variations in pixel intensities in the sequence of images.

15. A method of detecting whether captured images of an eye are from a living source comprising:
capturing a sequence of images of a retina of the eye wherein the images are represented by image data and the images in the sequence include at least one blood vessel;
aligning the sequence of images;
identifying a blood vessel that is common in the sequence of images;
determining the variations in the widths of the common blood vessel in the sequence of images; and
determining whether the captured images are from a living source based on the variations in the width of the common blood vessel.

16. A method of detecting whether a biometric is from a living source as recited in claim 14 wherein the captured images are determined to be from a non-living source if there is little or no variation in the widths of the common blood vessel in the sequence of images.

17. A method of detecting whether a biometric is from a living source as recited in claim 14 wherein the captured images of the sequence include the optic disk and the method includes locating the optic disk in the captured images of the sequence from the image data; and locating a common blood vessel in the captured images of the sequence with reference to the optic disk from the image data.

18. A method of detecting whether captured images of a biometric are from a living source comprising:
capturing a sequence of images of a biometric wherein the images are represented by image data and the images in the sequence include at least one blood vessel;
identifying a blood vessel common to each of the images in the sequence from the image data; and
analyzing an attribute of the common blood vessel represented by the image data in the sequence of images to determine whether the attribute of the common blood vessel changes in the sequence of images in accordance with a living source.

19. A method as recited in claim 18 wherein the attribute analyzed is the width of the common blood vessel.

20. A method as recited in claim 18 wherein the attribute analyzed is the intensity of pixels forming a portion of the image.

21. A method of detecting whether captured images of an eye are from a living source comprising:
capturing a sequence of images of the eye wherein the images are represented by pixel image data and the images include a common reference;
aligning the images represented by the pixel image data with respect to the common reference; and
analyzing an attribute of the eye represented in the sequence of images to determine whether the attribute changes in the sequence of images in accordance with a living source.

22. A method of detecting whether captured images of an eye are from a living source as recited in claim 21 wherein the common reference is the optic disk.

23. A method of detecting whether captured images of an eye are from a living source as recited in claim 21 wherein the common reference is at least one blood vessel.

24. A method of detecting whether captured images of an eye are from a living source as recited in claim 21 wherein the common reference is the main artery.

25. A method of detecting whether captured images of an eye are from a living source as recited in claim 21 wherein the attribute is the width of at least one blood vessel.

26. A method of detecting whether captured images of an eye are from a living source as recited in claim 21 wherein the attribute is pixel intensity associated with a blood vessel.

27. A method of detecting whether captured images of an eye are from a living source as recited in claim 21 wherein the attribute is the absorption or reflectivity of different wavelengths of light.

28. A method of detecting whether captured images of an eye are from a living source as recited in claim 21 wherein the attribute is movement of the eye.

29. A method of detecting whether captured images of an eye are from a living source as recited in claim 28 wherein the attribute is Saccadic movements of the eye.

30. A method of detecting whether captured images of an eye are from a living source as recited in claim 28 wherein the attribute is controlled eye movement.
